(19) United States
(12) Patent Application Publication
(10) Pub. No.: US 2010/0265833 A1
(43) Pub. Date: Oct. 21, 2010

(54) NETWORK BANDWIDTH DETERMINATION

(76) Inventors: Frank Y. Ou, Fremont, CA (US); Thomas Richard Gonzalez, Plano, TX (US); Martin Reckleben, San Jose, CA (US)

Correspondence Address: MAHAMEDI PARADICE KREISMAN LLP, 550 Winchester Boulevard, Suite 605, SAN JOSE, CA, 95128, US

(21) Appl. No.: 12/425,320

(22) Filed: Apr. 16, 2009

(51) Int. Cl. H04L 12/26

(52) U.S. Cl. 370/252

(57) ABSTRACT

A method for determining a bandwidth of a network system. A first device in the network transmits a plurality of test data during a first interval of time. A second device in the network receives an amount of the transmitted test data, wherein the amount of the test data received by the second device is less than a total amount of the test data transmitted by the first device during the first interval of time. The bandwidth of the network is then determined based on the amount of the test data that is received by the second device.

### TECHNICAL FIELD

The disclosure herein relates generally to network systems, and more specifically to determining the bandwidth of such network systems.

### BACKGROUND

A network system is generally made up of two or more end devices (e.g., computers or terminals) which communicate with one another via one or more data paths within the network. The data paths are typically made up of cables and other devices (e.g., routers, switches, repeaters, and/or terminals), all of which may affect the overall bandwidth of the network.

FIG. 1 illustrates a typical network system 100, including two network devices 110 and 120 connected to one another via a network infrastructure 150. Each of the network devices 110 and 120 may be, for example, a switch or router (or other device for communicating data over the network 150). As shown in FIG. 1, the network device 110 may transmit data to the network device 120, via the network infrastructure 150, at a given data rate (e.g., bit rate). However, the network device 120 may or may not receive the data at the rate transferred. For example, the actual data throughput of the network may be limited by the characteristics and/or qualities of the network infrastructure 150 (more specifically, by the devices connected along the data paths through which the data transfers take place). Accordingly, it may be desirable to test and/or determine the physical limitations of a network's bandwidth in order to better manage the data traffic through the network (e.g., to ensure that important data is not dropped or lost in communication)

Prior attempts to measure network bandwidth have typically involved transmitting test packets from one end of the network (e.g., network device 110) to another (e.g., network device 120) beginning at a low data rate, and determining whether or not the all of the transmitted test packets are successfully transmitted across the network. This process is then iteratively repeated, by incrementally increasing the transfer rate with each successive iteration, until packets begin to be dropped (e.g., until it is determined that network device 120 can no longer receive all of the data transmitted to it by network device 110). However, such techniques are typically very slow and cumbersome, often being performed in several phases/iterations, each iteration involving one or more finely-made adjustments.

It is therefore desirable to determine the bandwidth of a network in a more efficient manner, which minimizes the amount of system resources used while performing such tests and/or determinations.

### BRIEF DESCRIPTION OF THE DRAWINGS

The disclosure herein is illustrated by way of example, and not by way of limitation, in the figures of the accompanying drawings and in which like reference numerals refer to similar elements and in which:

FIG. 1 illustrates a typical network system;

FIG. 2 illustrates an exemplary network system which may be used to perform bandwidth measurement operations;

FIG. 3 illustrates an operation for determining the bandwidth of a network, which may be performed within a network system;

FIG. 4 illustrates another operation for determining the bandwidth of a network, which may be performed within a network system;

FIGS. 5A-5C illustrate exemplary methods for determining when to stop looking for additional test packets;

FIG. 6 illustrates another exemplary network system which may be used to perform bandwidth measurement operations;

FIG. 7 illustrates an operation for determining the bandwidth of a network, which may be initiated and terminated at a single network device;

FIG. 8 illustrates another operation for determining the bandwidth of a network, which may be performed by a network device;

FIG. 9 illustrates an alternative implementation for the network system of FIG. 5; and

FIG. 10 illustrates a block diagram depicting a computer system upon which an embodiment may be implemented.

### DETAILED DESCRIPTION

In embodiments disclosed herein, a network measurement is provided for determining the bandwidth of a network. In specific embodiments, the network bandwidth is determined by initially transmitting test packets, through a network system, from one network device to another at a transmission rate that is greater than or equal to the theoretical bandwidth of the network. In an embodiment, the network bandwidth may be determined in a single measurement step (i.e., testing phase). In other embodiments, the network measurement may be initiated and determined by a single network device, based on information that is “looped-back” by another network device.

The embodiments described herein provide a means for determining the bandwidth of a network by “overtaxing” the network (i.e., transmitting packets and/or bits of data through the network at a rate greater than that which the network is physically capable of handling). Thus, by forcing the network to drop at least some of the test packets (and/or test data), the number of test packets that are successfully transmitted through the network (i.e., from one end of the network to another) may then be used to determine the overall bandwidth of the network. Alternatively, or in addition, if no test packets are dropped when transmitting at the theoretical maximum data rate, then it may thus be concluded that the bandwidth of the network is at least equal to the theoretical maximum data rate.

For purposes of discussion, the term “test packet” is used herein to refer to any data packet used for purposes of determining (or testing) the network bandwidth. Furthermore, the term “incrementally adjusting” or “incremental adjustment” may be used herein to refer to a method of incrementing and/or decrementing the data transfer rate (e.g., of test packets) for purposes of determining the bandwidth of a network more precisely.

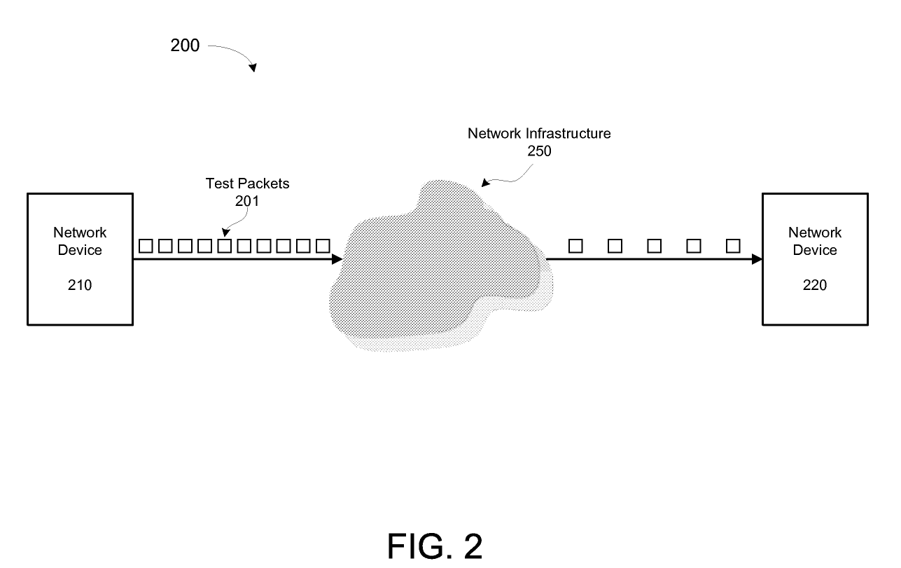

FIG. 2 illustrates an exemplary network system which may be used to perform bandwidth measurement operations. The network system 200 includes two network devices, 210 and 220, connected to one another via a network infrastructure 250. The network device 210 transmits a series of test packets 201, via the network infrastructure 250, to the network device 220. It should be noted that the payload of a test packet may include actual data to be interpreted by the network device 220 (or a computer/terminal connected to the network device 220), or alternatively, the payload may consist entirely of “junk” data. According to an embodiment, the series of test packets 201 are initially transmitted at a rate greater than or equal to the theoretical network bandwidth (i.e., the assumed maximum throughput of a data path between the network devices 210 and 220), thus resulting in at least some of the test packets being dropped prior to reaching the network device 220.

The network bandwidth may be determined based on the number of transmitted test packets that are successfully received by the network device 220. For example, assume that the network device 210 transmits 1000 test packets at a rate of 1 gigabit per second (Gb/s), and that only 500 of the transmitted packets actually reach the network device 220, then based on the ratio of transmitted versus received test packets, the network bandwidth between network devices 210 and 220 may be determined to be 500 Mb/s (i.e., half of 1 Gb/s). In other words, the network bandwidth (BW) may generally be determined based on the transmission rate (TR) of the test packets, the number of test packets transmitted (PT) by the network device 210, and the number of test packets received (PR) by the network device 220: BW=TR×(PR/PT).

In another embodiment, the network bandwidth may be determined by counting the total number of data bytes (and/or bits) received by the network device 220 during the measurement operation. For example, assume that the network device 210 transmits 1 gigabit of data within a 1 second interval of time, and that the network device 220 receives only 100 megabits of the transmitted data, then it may be determined that the network bandwidth is 100 Mb/s. In other words, the network bandwidth may also be determined based on the interval of time (TI) during which test packets are transmitted by the network device 210, and the amount of test data received (DR) by the network device 220 (e.g., in bits and/or bytes): BW=DR/TI.

The bandwidth measurement operations described above provide a quick and efficient means for determining the network bandwidth between two end points (e.g., network devices 210 and 220) in any network system. Accordingly, such embodiments may provide a means for determining the network bandwidth in a single operational step. The embodiments described above also provide a more robust means for determining the bandwidth of a network. For example, as long as the transfer rate is greater than the actual bandwidth of the network, there is no upper bound on the actual rate at which test data is transmitted. Thus, the bandwidth determination of FIG. 2 provides several advantages over existing means of measuring network bandwidth.

It should be noted that, while the foregoing techniques provide a good indication of the actual bandwidth of the network, the network bandwidth may be determined with a greater level of precision by using a combination of these techniques (i.e., as described above with respect to FIG. 2) with other bandwidth determination means (e.g., by incrementally adjusting the data transfer rate). Such combination may thus provide a more precise bandwidth determination using fewer steps (i.e., iterations) than would normally be required through use of such incremental bandwidth determination techniques alone (in general, a greater number of iterations results in a greater level of precision).

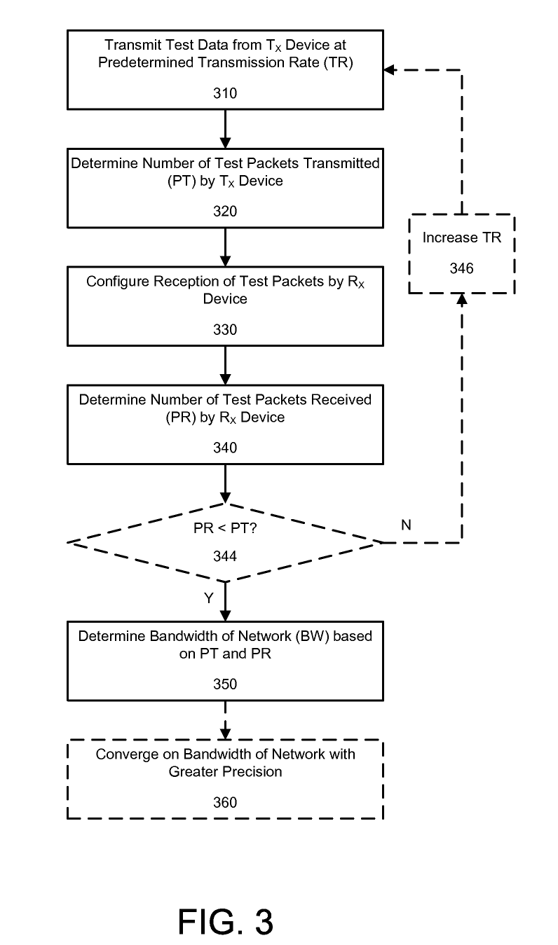

FIG. 3 illustrates an operation for determining the bandwidth of a network, which may be performed within a network system. At 310, test data is first transmitted by a network (Tₓ) device at a predetermined transmission rate (TR). According to an embodiment, TR is set at a value greater than or equal to a theoretical (or “ideal”) bandwidth of the network. For example, if the network under test is indicated to be a Gigabit Ethernet system, then the transmission rate for the test data should be greater than or equal to 1 Gb/s (i.e., TR≧1 Gb/s). On the other hand, if no theoretical bandwidth is known, then the transmission rate may be specified as the maximum bandwidth that the physical transmission lines (e.g., cables, wires, pipes, etc.) are able to handle. This may ensure that the test data is transmitted at a rate greater than or equal to the theoretical bandwidth of the network, since the rate of data transfers typically cannot exceed the maximum available bandwidth associated with any transmission medium in the network (or along a data path of the network).

At 320, the total number of test packets transmitted (PT) by the T_{X} device is determined. For example, a packet counter may be connected to the output of the T_{X} device which keeps a running tally of the total number of test packets transmitted. In another example, a user (e.g., an operator of the T_{X} device) may specify the total number and/or size of the test packets to be transmitted by the T_{X} device.

At 330, a network (Rₓ) device at another end of the network is configured to receive the transmitted test packets during a certain interval, or duration of time. For each transmitted test packet, there are a variety of factors (e.g., jitter and/or delay) which may affect its propagation through the network, thus making it difficult to predict the time at which the test packet will arrive at the R_{X} device (relative to its time of transmission from the T_{X} device). Therefore, the R_{X} device (or an operator thereof) should be configured to determine when to stop “looking for” (i.e., expecting or waiting to receive) test packets, so that the bandwidth determination operation may proceed.

According to an embodiment, the R_{X} device is configured to stop looking for test packets after a predetermined interval of time. For example, the interval of time may be measured from the time of transmission of the test packets (e.g., from the time the first or last test packet is transmitted), or alternatively, the interval of time may be measured from the time the first test packet is received at the R_{X} device.

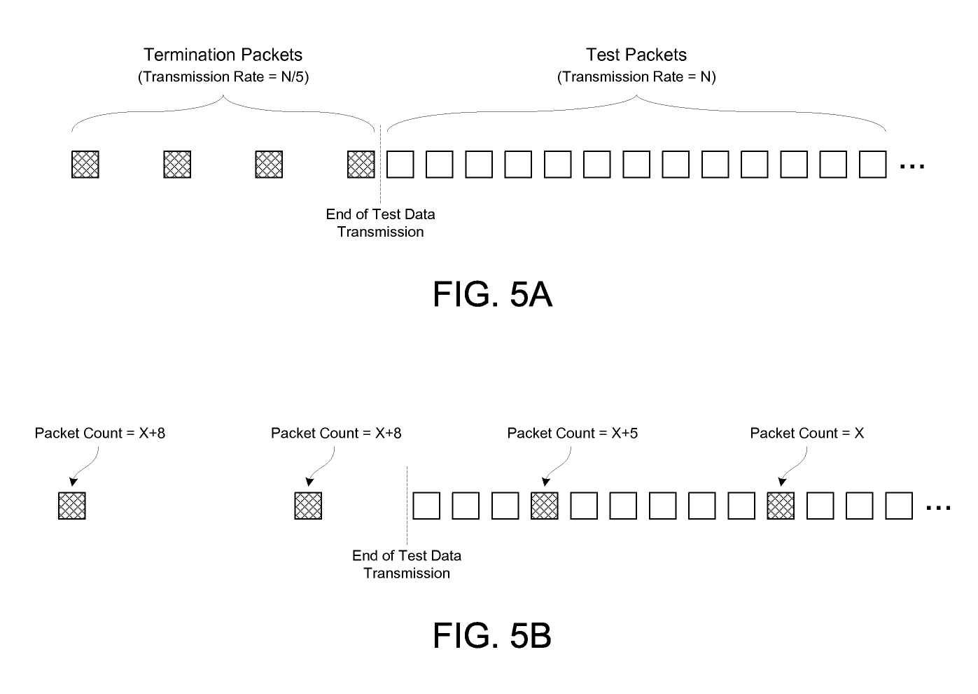

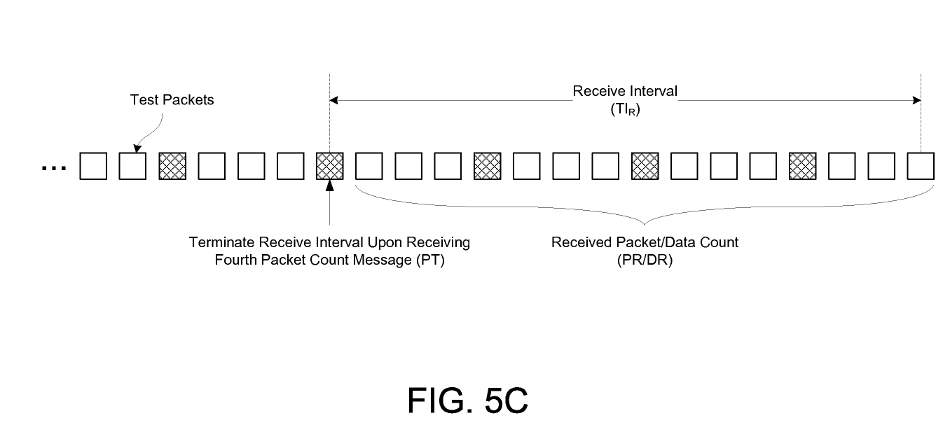

In another embodiment, the R_{X} device may stop looking for test packets upon receiving a “termination packet.” For example, the T_{X} device may transmit one or more termination packets (which may be any type of data packet carrying information specifying the termination of a test interval) upon completing transmission of the series of test packets. In addition, multiple termination packets may be transmitted (e.g., at a transmission rate that is significantly lower than the theoretical bandwidth of the network, as illustrated by example in FIG. 5A) to increase the probability that the R_{X} device will successfully receive at least one termination packet.

In yet another embodiment, the R_{X} device may be configured to stop looking for test packets upon determining how many test packets have been “sent” by the T_{X} device. For example, as illustrated in FIG. 5B, the T_{X} device may regularly transmit a packet count to the R_{X} device, indicating the cumulative number of test packets successfully transmitted by the Tₓ device. In a specific example, the IEEE 802.lag draft standard and ITU Y.1731 define a Continuity Check Message (CCM) which is transmitted regularly. Each CCM packet may include a user-definable Type Length Value (TLV) field. The T_{X} device may be configured to write the packet count (e.g., the updated PT value, as determined in step 320) to the TLV field of each of one or more CCM packets which are then transmitted to the R_{X} device in regular intervals.

The R_{X} device may thus determine when to stop looking for test packets upon identifying, from the packet count, that the prescribed number (or limit) of test packets have already been transmitted. For example, still referring to FIG. 5B, the R_{X} device may stop looking for test packets upon receiving two packet count messages (e.g., CCM packets) which indicate the same packet count. In other words, the R_{X} device may determine that a test data transmission cycle is over, based on the indication (in the packet count) that the T_{X} device has not transmitted any additional test data during a given interval (e.g., a CCM interval).

Alternatively, the R_{X} device may stop looking for test packets after receiving a predetermined number of packet count messages (e.g., CCM packets) from the T_{X} device. For example, as illustrated in FIG. 5C, the R_{X} device may specify a “receive interval” (within the overall test packet transmission interval) in which to determine the bandwidth of the network. In the specific example of FIG. 5C, the receive interval spans a duration of four packet count messages. Accordingly, the embodiment described with respect to FIG. 5C may preclude the need for determining the end of the test packet transmission cycle.

The total number of test packets received (PR) by the R_{X} device is then determined at 340. For example, a packet counter may be connected to the input port of the R_{X} device, which keeps a running tally of the total number of test packets received. The PR value may be continuously updated until the end of the test data transmission interval (e.g., as shown in FIGS. 5A and 5B) or, alternatively, the PR value may be updated for only the duration of the receive interval (e.g., as shown in FIG. 5C).

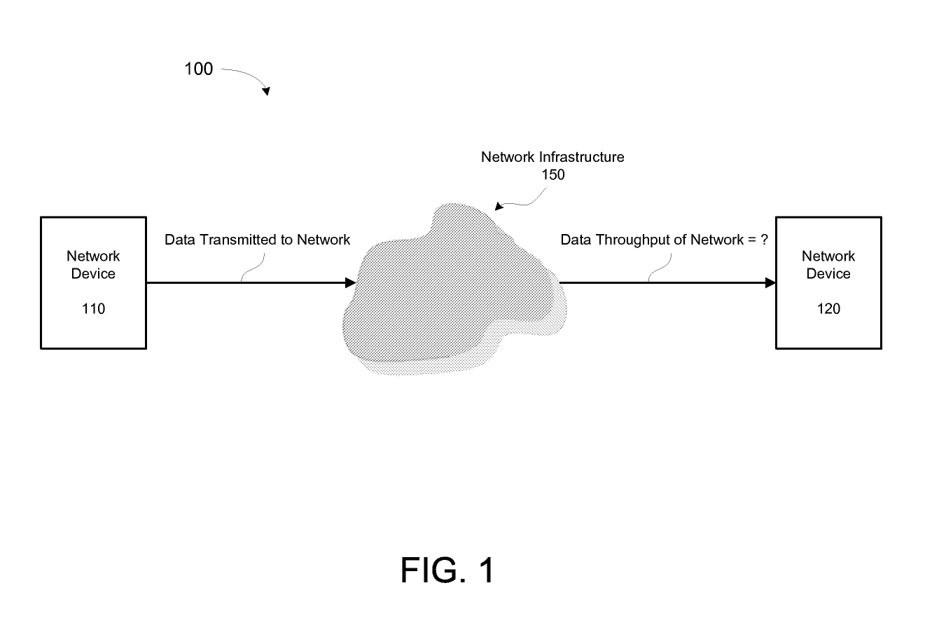

At 350, the network bandwidth is determined based on the total number of test packets transmitted and the total number of test packets received. For example, the network bandwidth may be determined as a proportion of the transmission rate of the test packets: BW=TR×(PR/PT) (e.g., as described above, with respect to FIG. 1). It should be noted, however, that the PT and PR values may correspond to the number of test packets transmitted and received, respectively, during a receive interval that is shorter in duration the overall transmission interval for the test packets. For example, as shown in FIG. 5C, PR may be determined based on the count of received test packets during the specified receive interval, while PT may be determined from the last packet count message of the receive interval (signaling the end of the receive interval).

According to an embodiment, the network bandwidth may be “converged upon” (i.e., determined) with a greater level of precision using incremental bandwidth determination techniques, at 360. For example, the BW value determined at the end of step 350 may be used as the transmission rate for a subsequent transmission of test packets. Then, depending on whether any of the test packets are dropped, the transmission rate may be incrementally adjusted (i.e., increased and/or decreased) until the bandwidth is determined (or converged upon) with the desired level of precision.

In an alternative embodiment, the total number of packets received may be compared with the total number of packets sent, at 344. For example, if it is determined that the R_{X} device is able to receive all of the test packets transmitted by the T_{X} device (i.e., PR=PT), then the transmission rate may be increased, at 346, and the bandwidth measurement operation subsequently restarted, at 310. If, however, the transmission rate of the test packets is equal to the theoretical bandwidth of the network, and no packets were dropped, then no further adjustment may be necessary (e.g., assuming the purpose of the test is to determine whether the actual bandwidth of the network is at least equal to the theoretical, or advertised, bandwidth). Thus, the step of comparing the packets received with packets transmitted, at 344, may ensure that the bandwidth determination operation of FIG. 3 is executed properly.

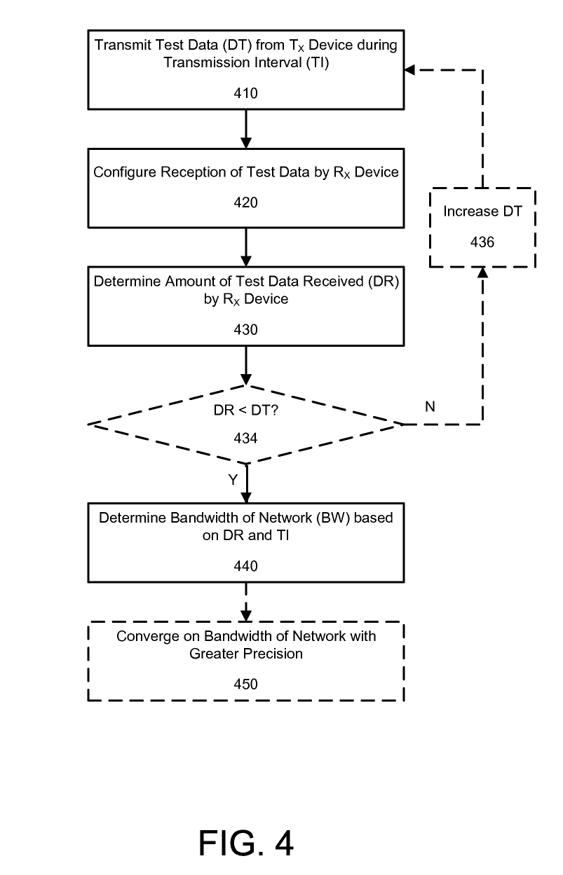

FIG. 4 illustrates another operation for determining the bandwidth of a network, which may be performed within a network system. At 410, test data is transmitted from a Tₓ device during a prescribed (or predetermined) transmission interval (TI). According to an embodiment, the amount of test data (DT) transmitted (and/or the transmission interval) is configured such that the transmission rate (TR=DT/TI) of the test data is greater than or equal to a theoretical bandwidth of the network. For example, if the theoretical bandwidth is determined to be 1 Gb/s, then assuming a transmission interval of one second, the amount of transmitted data should be greater than or equal to 1 Gb (i.e., DT/TI≧1 Gb/s). As described above, with respect to FIG. 3, the theoretical bandwidth may be a predetermined value (e.g., an assumed or specific bandwidth value which may be indicated by a manufacturer or service provider) or an overestimate of the actual bandwidth (e.g., based on known characteristics of the physical transmission mediums used in the network).

At 420, a R_{X} device at another end of the network is configured to receive the transmitted test data during a certain interval, or duration of time. For example, the R_{X} device may be configured to stop looking for test data after a predetermined interval of time. The interval of time may be calculated from the time of transmission of the test data (e.g., from the time the first or last bit, or byte, of test data is transmitted), or alternatively, the interval of time may be calculated from the time a bit (or byte) of test data is first received at the R_{X} Device. Furthermore, the interval of time may be equal to a multiple of the transmission interval (e.g., twice the transmission interval).

Alternatively (or in addition), the R_{X} device may be configured to stop looking for test packets upon receiving data corresponding to termination information, or a termination packet (e.g., as described above, with respect to FIGS. 3 and 5A-5C). For example, the Rₓ device may stop looking for test packets upon receiving one or more termination packets at the end of the test data transmission cycle (e.g., as shown in FIG. 5A). In another example, the R_{X} device may stop looking for test packets upon determining that a packet count included in two or more packet count messages (e.g., CCM packets), transmitted from the T_{X} device, has not changed (e.g., as shown in FIG. 5B). In yet another example, the R_{X} device may stop looking for test packets after receiving a predetermined number of packet count messages from the T_{X} device (e.g., as shown in FIG. 5C).

The total amount of test data received (DR) by the R_{X} device is then determined at 430. For example, a bit (or byte) counter may be connected to the input port of the R_{X} device, which keeps a running tally of the total number of bits (and/or bytes) of test data received. The DR value may be continuously updated until the end of the test data transmission interval (e.g., as shown in FIGS. 5A and 5B) or, alternatively, the DR value may be updated for only the duration of the receive interval (e.g., as shown in FIG. 5C).

At 440, the network bandwidth is determined based on the total amount of test data received by the R_{X} device. For example, the network bandwidth may be determined as the total throughput of the test data transmitted during the prescribed transmission interval: BW=DR/TI (e.g., as described above, with respect to FIG. 1). It should be noted, however, that the DR value may correspond to the amount of test data received during a receive interval (TI_{R}) that is shorter in duration than the overall transmission interval TI (e.g., as shown in FIG. 5C).

For example, assuming the packet count messages are transmitted at predetermined intervals, then TI_{R} can be easily determined based on: i) the number of packet count messages (N) spanned by the receive interval, and ii) the amount of elapsed time (T) between transmission each packet count message (i.e., TI_{R}=N×T). Thus, alternatively, the network bandwidth may be determined as the total throughput of the test data transmitted during the prescribed receive interval: BW=DR/TI_{R}.

According to an embodiment, the network bandwidth may be converged upon with a greater level of precision using incremental bandwidth determination means, at 450. For example, the BW value determined at the end of step 440 may be incrementally adjusted until the network bandwidth is determined at the desired level of precision (e.g., as described above, with respect to FIGS. 1 and 3).

In an alternative embodiment, the total amount of test data received may be compared with the total amount of test data transmitted, at 434. For example, if it is determined that the RX device is able to receive the entire amount of test data transmitted by the TX device (i.e., DR=DT), then the amount of test data allocated for transmission may be increased (and/or the transmission interval decreased), at 436. The bandwidth measurement operation may then be subsequently restarted, at 410. If, however, the transmission rate of the test packets is equal to the theoretical bandwidth of the network, and no packets were dropped, then no further adjustment may be necessary (depending on the implementation). Accordingly, the step of comparing the test data received with the test data transmitted, at 434, may help ensure successful execution of the bandwidth determination operation of FIG. 4.

It should be noted that the embodiments described above, with respect to FIGS. 3 and 4, provide much faster and more efficient means for determining the bandwidth of a network in comparison to prior art attempts. Furthermore, such embodiments may significantly reduce the amount of time in which the bandwidth measurement operation “hangs up” the network for testing purposes (i.e., restricts the flow of user data traffic).

FIG. 5 illustrates another exemplary network system which may be used to perform bandwidth measurement operations. The network system 600 includes two network devices, 610 and 620, connected to one another via a network infrastructure 650. In operation, the network device 610 transmits a series of test packets 601, via the network infrastructure 650, to the network device 620. According to an embodiment, the series of test packets 601 are initially transmitted at a rate that is greater than or equal to the theoretical network bandwidth, thus resulting in at least some of the test packets being dropped prior to reaching the network device 620. Alternatively, if no test packets are dropped, it may be concluded that the network bandwidth is at least equal to the theoretical maximum. The network device 620 then transmits “return” packets 602 back to the network device 610, indicating the number of test packets successfully received. For purposes of discussion, return packets may correspond to any packets of data transmitted by the network device 620 to the network device 610.

For example, the network device 620 may include a packet counter which keeps a running tally of the number of test packets (or bits of test data) received from the network device 610. An updated packet count may then be encoded in each of the return packets 602, which are then transmitted back to the network device 610 in regular intervals (e.g., after predetermined intervals of time). In a specific example, the network device 620 may write the packet count to the TLV field of a CCM packet, and thus transmit the packet count back to the network device 610 using one or more CCM packets.

Alternatively, the network device 620 may transmit a return packet for each test packet received (e.g., the network device 620 may “loop-back,” or re-transmit the test packets as they arrive), the network device 610 keeping count of the number of packets (or bits of test data) looped back by the network device 620. This allows the network device 610 to count/determine the number of test packets successfully received by the network device 620.

With regard to CCM packets and other return packets, any of the embodiments described in U.S. patent application Ser. No. 12/139,387 (incorporated by reference herein, in its entirety) may be implemented by the network device 620 and/or 610 such as described with other embodiments disclosed herein.

The network bandwidth may then be determined based on the number of test packets received by the network device 620. As described above, with respect to FIG. 2, the network bandwidth may be determined based on the transmission rate of the test packets, the number of test packets transmitted by the network device 610, and the number of test packets received by the network device 620 (e.g., BW=TR×(PR/PT)). Alternatively, the network bandwidth may be determined based on the interval of time in which test packets are initially transmitted by the network device 610, and the amount of test data (e.g., in bits and/or bytes) received by the network device 620 (e.g., BW=DR/TI).

According to an embodiment, the return (or CCM) packets may be taken into consideration when determining the bandwidth of the network. For example, CCM packets may be transmitted as part of a standard network operation (i.e., even when test packets are not used), and may thus be properly included in the bandwidth calculation. In the case where return packets are used only for bandwidth testing purposes, it may be desirable to exclude such return packets from the bandwidth determination.

It should be noted that the network bandwidth may be determined with a greater level of precision by combining the foregoing embodiments, described with respect to FIG. 5, with other incremental bandwidth determination means (e.g., as described above, with respect to FIG. 2).

The bandwidth measurement operations described with respect to FIG. 5 provide additional advantages over the embodiments of FIGS. 2-4. For example, in addition to providing a quick and efficient means for determining the network bandwidth between two end points in any network system (e.g., which may involve just a single operational step), the foregoing bandwidth measurement operations may initiate (e.g., transmission of test packets) and terminate (e.g., calculation of the bandwidth) at just one end of the network. Thus, a user (or tester) may perform the entire bandwidth determination locally (i.e., through a single network device 610).

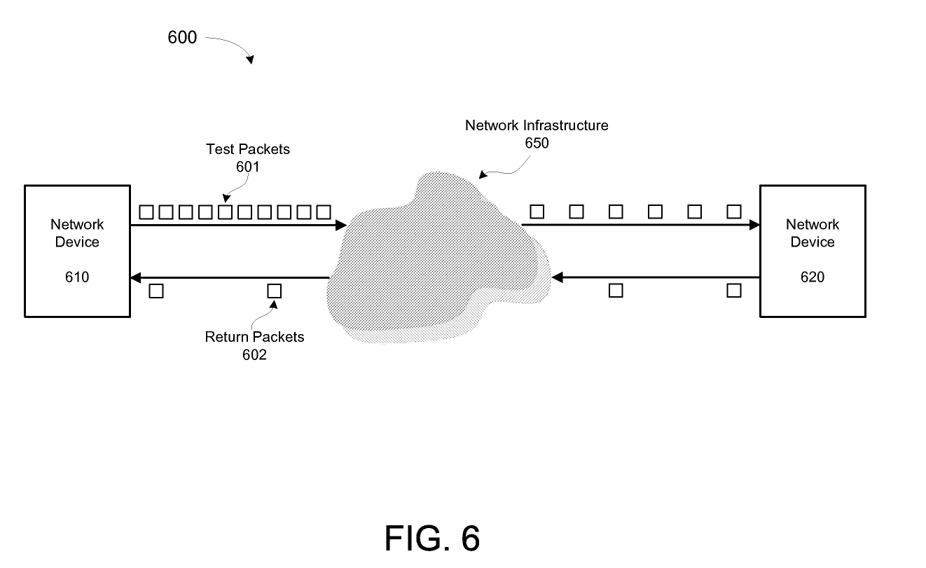

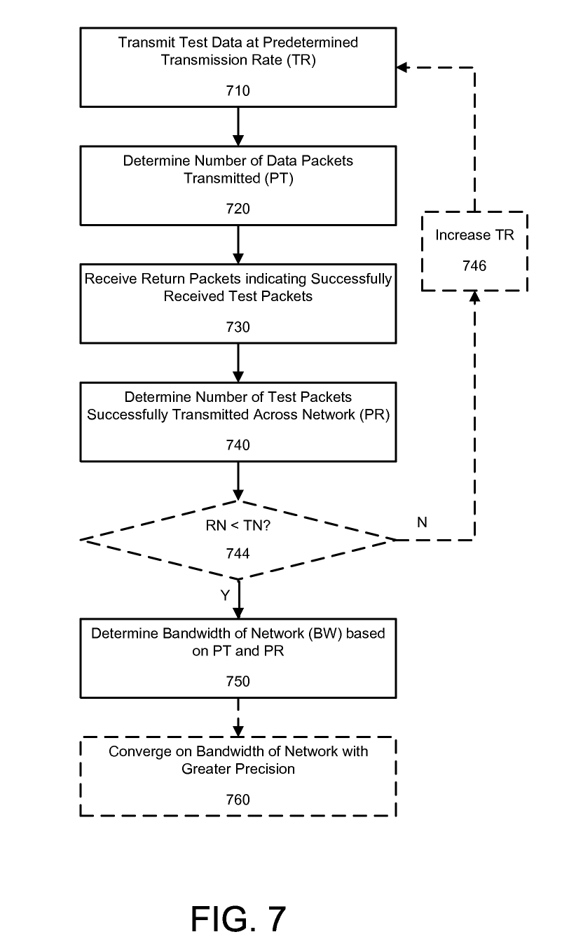

FIG. 7 illustrates an operation for determining the bandwidth of a network, which may be initiated and terminated at a single network device. An exemplary operation is herein discussed with reference to the network system 600 of FIG. 6.

At 710, test data is first transmitted, by the network device 610, at a predetermined transmission rate (TR). According to an embodiment, TR is set at a value greater than or equal to a theoretical bandwidth of the network. As described above, with respect to FIGS. 3 and 4, the theoretical bandwidth may be a predetermined value or an estimate of the actual network bandwidth.

At 720, the total number of transmitted test packets transmitted (PT) is determined. For example, the total number of transmitted test packets may be determined by counting the total number of test packets that are output. Alternatively, a user may specify the total number and/or size of the test packets to be transmitted.

At 730, return packets are received by the network device 610, from the network device 620, the return packets indicating the number of test packets that were successfully received by the network device 620. For example, each return packet may be encoded with an updated packet count, indicating the cumulative number of test packets received by the network device 620. The network device 610 may thus continue to wait for return packets for a predetermined duration of time, which is preferably long enough to ensure that any test packets that were successfully received by the network device 620 have been accounted for.

According to an embodiment, the network device 620 may transmit return packets at regular intervals (e.g., as CCM packets). The network device 610 may thus determine when to stop looking for additional return packets upon receiving two or more (i.e., depending on the frequency at which return packets are transmitted) subsequent return packets indicating that there was no change in the cumulative number of test packets received by the network device 620, during such interval(s) (e.g., as described above with respect to FIG. 5B).

According to another embodiment, the network device 620 may loop-back the test packets as they are received. In other words, the network device 610 may receive a return packet for each test packet successfully transmitted through to the other end of the network. The network device 610 may transmit a number of termination packets at the end of the series of test packets (e.g., as described above, with respect to FIG. 5A) to indicate the end of a transmission interval. Thus, the network device 610 may stop looking for return packets upon receiving a looped-back termination packet.

Alternatively, the network device 610 may regularly transmit a packet count message (e.g., using CCM packets) to the network device 620, indicating the cumulative number of test packets successfully transmitted by the network device 610. The network device 620 may similarly loop-back these packet count messages upon reception. Thus, the network device 610 may stop looking for return packets upon receiving one or more looped-back packet count messages (e.g., as described above with respect to FIGS. 5B and 5C).

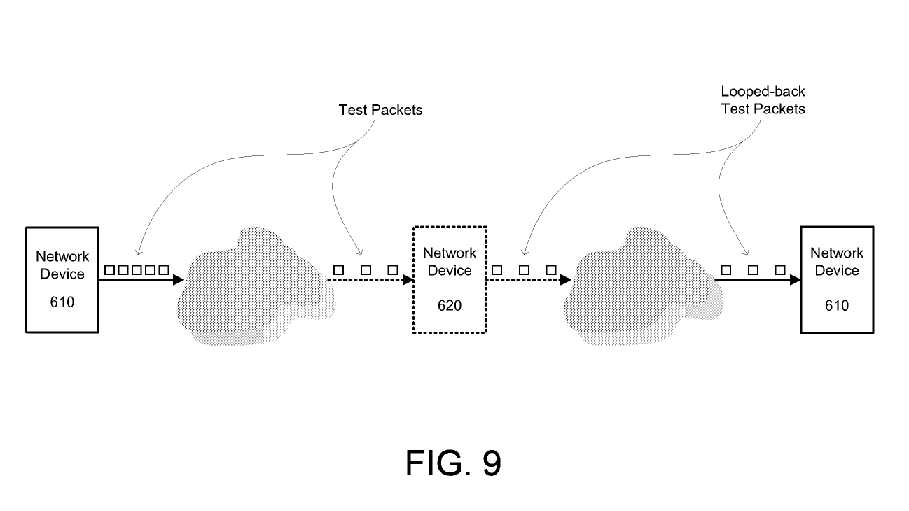

It should be noted that, when the network device 620 loops back each test packet received, the network device 610 effectively operates as both the T_{X} and R_{X} devices (e.g., illustrated by example in FIG. 9). Thus, the network device 610 may perform the operations of both T_{X} and R_{X} devices, as described above with respect to FIGS. 3 and 4, for purposes of determining the bandwidth of the network.

The total number of test packets (PR) successfully transmitted through to the network device 620 is then determined, at 740. For example, this number may be directly obtained by interpreting the cumulative packet count encoded in the return packets, with the highest overall packet count indicating the total number of test packets received by the network device 620.

Alternatively, the return packets may be counted as they are received (i.e., looped-back from the network device 620), wherein the total number of return packets received is indicative of the number of test packets successfully received by the network device 620 (e.g., assuming that the network device 620 transmits a return packet for each test packet received). Thus, the PR value may be continuously updated until the end of a test data transmission interval (e.g., as shown in FIGS. 5A and 5B) or, alternatively, the PR value may be updated for only the duration of a receive interval (e.g., as shown in FIG. 5C).

At 750, the network bandwidth is determined based on the total number of test packets initially transmitted and the total number of those test packets that were successfully received by the network device 620. For example, the network bandwidth may be determined as a proportion of the transmission rate of the test packets: BW=TR×(PR/PT). It should be noted that the PT and PR values may correspond to the number of test packets transmitted and received, respectively, during a receive interval within the overall transmission interval (e.g., as described above, with respect to FIG. 5C).

In further embodiments, the network bandwidth may be converged upon with a greater level of precision using incremental bandwidth determination techniques, at 760. For example the BW value determined at the end of step 750 may be incrementally adjusted until the network bandwidth is determined at the desired level of precision (e.g., as described above, with respect to FIGS. 1 and 3).

In an alternative embodiment, the total number of test packets received may be compared with the total number of packets transmitted, at 744. Accordingly, the step of determining the network bandwidth, at 750, may be performed only after determining that at least some of the originally transmitted test packets were dropped by the network device 620 (i.e., PR<PT). Otherwise, the number of test packets to be transmitted is increased, at 746, and the bandwidth measurement operation is subsequently restarted, at 710. If, however, the transmission rate of the packets is equal to the theoretical bandwidth of the network, and no packets were dropped, then no further adjustment may be necessary (e.g., if the purpose of the test is to determine whether the actual bandwidth of the network is at least equal to the advertised bandwidth).

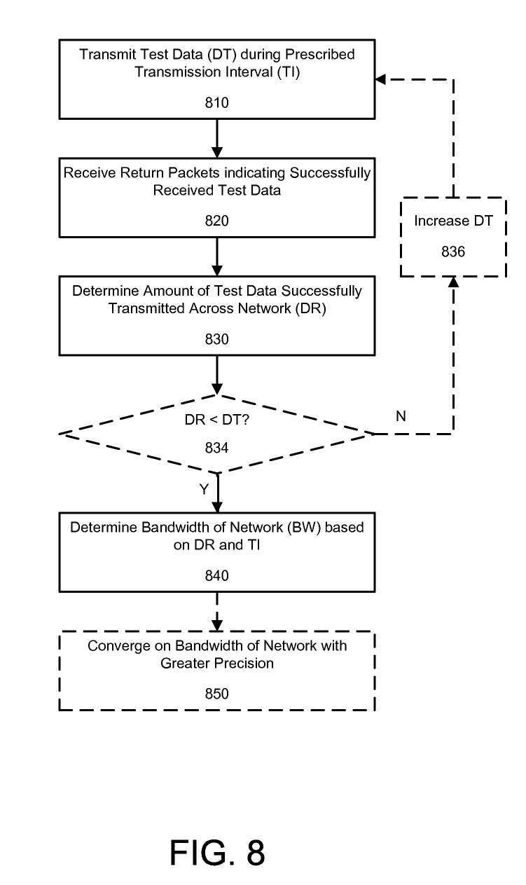

FIG. 8 illustrates another operation for determining the bandwidth of a network, which may be performed by a network device. An exemplary operation is herein discussed with reference to the network system 600 of FIG. 5.

At 810, test data is transmitted, by the network device 610, during a prescribed transmission interval (TI). According to an embodiment, the amount of test data (DT) transmitted (and/or the transmission interval) is configured such that the transmission rate (i.e., TR=DT/TI) of the test data is greater than or equal to a theoretical bandwidth of the network. As described above, with respect to FIGS. 3 and 4, the theoretical bandwidth may be a predetermined value or an overestimate of the actual network bandwidth.

At 820, return packets are received from the network device 620, in response to the transmitted test data, the return packets indicating the amount of test data that was successfully received at another end of the network. As described above, in reference to FIG. 7, each return packet may be encoded with an updated data count indicating the cumulative amount of test data received by the network device 620. The network device 610 may thus determine to stop looking for additional return packets when two or more subsequent return packets indicate that there was no change in the cumulative amount of test data received by the network device 620. Alternatively (or in addition), the network device 610 may continue waiting to receive return packets for a predetermined period of time.

According to an embodiment, test data that is successfully received by the network device 620 is looped back to the network device 610 (e.g., in the form of return packets). Thus, the network device 610 may operate as both T_{X} and R_{X} devices in determining the bandwidth of the network (e.g., as described above with respect to FIGS. 6 and 9).

The total amount of test data (DR) that has been successfully transmitted through to the network device 620 is then determined, at 830. For example, this number may be directly obtained by interpreting the data count encoded in the return packets, with the highest overall data count indicating the total amount of test data received by the network device 620.

Alternatively, DR may be determined by counting the amount of received loopback data, wherein the total amount of data looped back to the network device 610 is indicative of the amount of test data successfully received by the network device 620 (e.g., assuming that the network device 620 loops back any test data received). Thus, the DR value may be continuously updated until the end of a test data transmission interval (e.g., as shown in FIGS. 5A and 5B) or, alternatively, the DR value may be updated for only the duration of a receive interval (e.g., as shown in FIG. 5C).

At 840, the network bandwidth is determined based on the initial transmission interval for the test data and the total amount of data that was successfully received by the network device 620. For example, the network bandwidth may be determined as the total throughput of the test data transmitted within the prescribed transmission interval: BW=DR/TI. Alternatively, the network bandwidth may be determined as the total throughput of the test data transmitted during a prescribed receive interval: BW=DR/TI_{R} (e.g., as described above in reference to FIG. 5C).

In further embodiments, the network bandwidth may be converged upon with a greater level of precision using incremental bandwidth determination techniques, at 850. For example, the BW value determined at the end of step 840 may be incrementally adjusted until the network bandwidth is determined at the desired level of precision (e.g., as described above, with respect to FIGS. 1 and 3).

In an alternative embodiment, the total amount of test data received may be compared with the total amount of test data sent, at 834. Accordingly, the step of determining the network bandwidth, at 840, may be performed only after determining that at least some of the originally transmitted test data was dropped by the network device 620 (i.e., DR<DT). Otherwise, the amount of test data to be transmitted is increased (and/or the transmission interval is decreased), at 836, and the bandwidth measurement operation is subsequently restarted, at 810. If, however, the transmission rate of the packets is equal to the theoretical bandwidth of the network, and no packets were dropped, then no further adjustment may be necessary.

It should be noted that the embodiments described above, with respect to FIGS. 6 and 7, provide several advantages over prior art attempts to measure the bandwidth of a network. In addition to providing quick and efficient means of bandwidth determination, the embodiments of FIGS. 6 and 7 enable all of the bandwidth testing to be performed locally (i.e., on a single device at one end of the network), thus limiting the amount of hardware and/or other resources (e.g., users or testers) necessary to perform such bandwidth measurement operations.

The embodiments described above may be implemented in a programmed general-purpose or special-purpose computer system or in a network of computer systems. Alternatively, the embodiments may be implemented in a device that includes hardwired logic for carrying out the above-described operations, or any combination of programmed processors and hardwired logic.

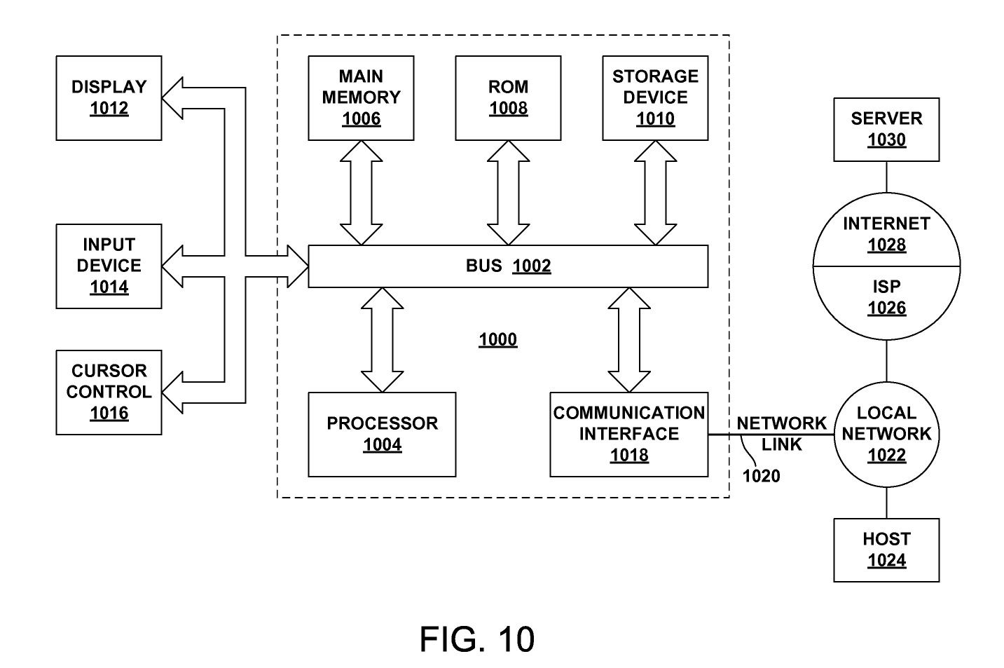

FIG. 10 is a block diagram that depicts a computer system 1000 upon which an embodiment may be implemented. Computer system 1000 includes a bus 1002 or other communication mechanism for communicating information, and a processing entity 1004 coupled with bus 1002 for processing information. The processing entity 1004 may include any number of general purpose and/or special purposes processors co-located within a single computing system or distributed over a network of computing systems. Computer system 1000 also includes a main memory 1006, such as a random access memory (RAM) or other dynamic storage device, coupled to bus 1002 for storing information and instructions to be executed by processing entity 1004, including the above described data values and instructions to be executed by processing entity 1004 to carry out the above-described operations. Main memory 1006 also may be used for storing temporary variables or other intermediate information during execution of instructions to be executed by processing entity 1004. Computer system 1000 further includes a read only memory (ROM) 1008 or other static storage device coupled to bus 1002 for storing static information and instructions for processing entity 1004. A storage device 1010, such as a magnetic disk or optical disk, is provided and coupled to bus 1002 for storing information and instructions, such as those described above.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processing entity 1004. Another type of user input device is cursor control 1016, such as a mouse, a trackball, or cursor direction keys for communicating direction information and command selections to processing entity 1004 and for controlling cursor movement on display 1012. This input device typically has two degrees of freedom in two axes, a first axis (e.g., x) and a second axis (e.g., y), that allows the device to specify positions in a plane.

The invention is related to the use of computer system 1000 for implementing the techniques described herein. According to one embodiment of the invention, those techniques are performed by computer system 1000 in response to processing entity 1004 executing one or more sequences of one or more instructions contained in main memory 1006. Such instructions may be read into main memory 1006 from another computer-readable medium, such as storage device 1010. Execution of the sequences of instructions contained in main memory 1006 causes processing entity 1004 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processing entity 1004 for execution. Such a medium may take many forms, including but not limited to, non-volatile media, volatile media, and transmission media. Non-volatile media includes, for example, optical or magnetic disks, such as storage device 1010. Volatile media includes dynamic memory, such as main memory 1006. Transmission media includes coaxial cables, copper wire and fiber optics, including the wires that comprise bus 1002. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processing entity 1004 for execution. For example, the instructions may initially be carried on a magnetic disk of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processing entity 1004 retrieves and executes the instructions. The instructions received by main memory 1006 may optionally be stored on storage device 1010 either before or after execution by processing entity 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are exemplary forms of carrier waves transporting the information.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processing entity 1004 as it is received, and/or stored in storage device 1010, or other non-volatile storage for later execution. In this manner, computer system 1000 may obtain application code in the form of a carrier wave.

The section headings in the preceding detailed description are provided for convenience of reference only, and in no way define, limit, construe or describe the scope or extent of such sections. Also, while the invention has been described with reference to specific exemplary embodiments thereof, various modifications and changes may be made thereto without departing from the broader spirit and scope of the invention. For example, features or aspects of any of the embodiments may be applied, at least where practicable, in combination with any other of the embodiments or in place of counterpart features or aspects thereof. The specification and drawings are, accordingly, to be regarded in an illustrative rather than restrictive sense.

What is claimed is:

1. A method for determining a bandwidth of a network system, the method comprising:
transmitting a plurality of test data, over the network, from a first device to a second device during a first interval;
receiving an amount of the test data at the second device; and
determining a bandwidth of the network based, at least in part, on the amount of the test data received by the second device, wherein the amount of test data received by the second device is less than a total amount of the test data transmitted by the first device during the first interval.

2. The method of claim 1 wherein the amount of test data received by the second device comprises at least one of a number of packets or bits of data.

3. The method of claim 2 wherein determining a bandwidth of the network comprises determining the bandwidth to be substantially equal to the number of bits received by the second device relative to the first interval.

4. The method of claim 1 wherein transmitting a plurality of test data comprises transmitting the plurality of test data at a first rate corresponding to a theoretical bandwidth of the network.

5. The method of claim 4, further comprising determining the theoretical bandwidth based on at least one of: (i) a predetermined bandwidth provided by a service provider of the network system, or (ii) a maximum bandwidth that a data transmission medium within the network is capable of handling.

6. The method of claim 4 wherein determining a bandwidth of the network comprises determining the bandwidth as a proportion of the first rate, wherein the proportion is based on a number of packets of test data received by the second device relative to a total number of packets of test data transmitted by the first device during the first interval.

7. The method of claim 4, further comprising transmitting one or more termination packets, from the first device to the second device, upon completing transmission of the plurality of test packets.

8. The method of claim 7 wherein transmitting one or more termination packets comprises transmitting the one or more termination packets at a second rate, and wherein the second rate is less than the first rate.

9. The method of claim 7 wherein determining a bandwidth of the network comprises:
counting a number of bits of test data received by the second device prior to receiving the one or more termination packets; and
determining the bandwidth to be substantially equal to the number of bits received by the second device relative to the first interval.

10. The method of claim 7 wherein determining a bandwidth of the network comprises:
counting a number of packets of test data received by the second device prior to receiving the one or more termination packets; and
determining the bandwidth as a proportion of the first rate, wherein the proportion is based on the number of packets received by the second device relative to a total number of packets of test data transmitted by the first device during the first interval.

11. The method of claim 1 wherein transmitting a plurality of test packets further comprises transmitting a count value from the first device to the second device, the count value indicating a cumulative number of test packets transmitted by the first device.

12. The method of claim 11 wherein transmitting a count value comprises transmitting a packet count message after each of a plurality of intervals, within the first interval, wherein the count message includes the count value.

13. The method of claim 12 wherein a duration of time associated with each of the plurality of intervals is the same.

14. The method of claim 13 wherein the packet count message is a connectivity check message.

15. The method of claim 12 wherein determining a bandwidth of the network comprises:
counting a number of bits of test data received by the second device, until receiving at least two packet count messages having substantially equal count values; and
determining the bandwidth to be substantially equal to the number of bits received by the second device relative to the first interval.

16. The method of claim 12 wherein determining a bandwidth of the network comprises:
counting a number of packets of test data received by the second device, until receiving at least two packet count messages having substantially equal count values; and
determining the bandwidth as a proportion of the first rate, wherein the proportion is based on the number of packets received by the second device relative to a total number of packets of test data transmitted by the first device during the first interval.

17. The method of claim 16, further comprising determining the total number of packets of test data transmitted by the first device during the first interval based on the count values of the at least two packet count messages.

18. The method of claim 12 wherein determining a bandwidth of the network comprises:
counting a number of bits of test data received by the second device, until receiving a predetermined number of packet count messages; and
determining the bandwidth to be substantially equal to the number of bits received by the second device relative to a second interval, wherein the second interval corresponds to a duration of time needed to transmit the predetermined number of packet count messages.

19. The method of claim 18 wherein the second interval is less than the first interval.

20. The method of claim 12 wherein determining a bandwidth of the network comprises:
counting a number of packets of test data received by the second device, until receiving a predetermined number of packet count messages; and
determining the bandwidth as a proportion of the first rate, wherein the proportion is based on the number of packets received by the second device relative to a number of test packets transmitted by the first device during a second interval, and wherein the second interval corresponds to a duration of time needed to transmit the predetermined number of packet count messages.

21. The method of claim 20, further comprising determining the number of packets of test data transmitted by the first device during the second interval based on the count value of at least one of the received packet count messages.

22. The method of claim 1 wherein determining a bandwidth of the network comprises counting the amount of test data received by the second device during a third interval, wherein the third interval corresponds to a predetermined duration of time.

23. The method of claim 1, wherein determining a bandwidth of the network comprises:
determining whether the amount of test data received by the second device is less than the total amount of the test data transmitted by the first device; and
if it is determined that the amount of test data received by the second device is not less than the total amount of the test data transmitted by the first device, transmitting another plurality of test data from the first device to the second device at a third rate, wherein the third rate is greater than the first rate.

24. A method, for determining a bandwidth of a network system, to be performed by a first device coupled to the network, the method comprising:
transmitting a plurality of test data, over the network, to a second device during a first interval;
receiving one or more packets from the second device, the one or more packets indicating an amount of test data received by the second device; and
determining a bandwidth of the network based, at least in part, on the amount of test data indicated by the one or more packets, wherein the amount of test data is less than a total amount of the test data transmitted during the first interval.

25. The method of claim 24 wherein the amount of data received by the second device comprises at least one of a number of packets or bits of data.

26. The method of claim 25 wherein determining a bandwidth of the network comprises determining the bandwidth to be substantially equal to the number of bits received by the second device, as indicated by the one or more packets, relative to the first interval.

27. The method of claim 24 wherein transmitting a plurality of test data comprises transmitting the plurality of test data at a first rate corresponding to a theoretical bandwidth of the network.

28. The method of claim 27, further comprising determining the theoretical bandwidth based on at least one of: (i) a predetermined bandwidth provided by a service provider of the network, or (ii) a maximum bandwidth that a data transmission medium within the network is capable of handling.

29. The method of claim 27 wherein determining a bandwidth of the network comprises determining the bandwidth as a proportion of the first rate, wherein the proportion is based on a number of packets of test data received by the second device, as indicated by the one or more packets, relative to a total number of packets of test data transmitted during the first interval.

30. The method of claim 24 wherein each of the one or more packets received from the second device includes a count value indicating a cumulative amount of test data received by the second device.

31. The method of claim 30 wherein determining a bandwidth of the network comprises determining the amount of data received by the second device to be substantially equal to the count values of two or more of the packets received from the second device, if the count values are the same.

32. The method of claim 30 wherein receiving one or more packets from the second device comprises receiving the one or more packets at regular intervals.

33. The method of claim 32 wherein the one or more packets include a connectivity check message.

34. The method of claim 27 wherein the second device is configured to loop back data received from the first device, and wherein the one or more packets received from the second device correspond, respectively, to one or more packets of the test data looped back from the second device.

35. The method of claim 34, further comprising transmitting one or more termination packets to the second device upon completing transmission of the plurality of test data.

36. The method of claim 35 wherein determining a bandwidth of the network comprises:
counting a number of bits of test data looped back from the second device prior to receiving the one or more termination packets; and
determining the bandwidth to be substantially equal to the number of bits looped back from the second device relative to the first interval.

37. The method of claim 35 wherein determining a bandwidth of the network comprises:
counting a number of packets of test data looped back from the second device prior to receiving the one or more termination packets; and
determining the bandwidth as a proportion of the first rate, wherein the proportion is based on the number of packets looped back from the second device relative to a total number of packets of test data transmitted by the first device during the first interval.

38. The method of claim 28 wherein transmitting a plurality of test data further comprises transmitting a packet count message to the second device after each of a plurality of intervals, within the first interval, wherein the packet count message includes a count value indicating a cumulative amount of test data transmitted the first device.

39. The method of claim 38 wherein transmitting the packet count message is a connectivity check message.

40. The method of claim 38 wherein determining a bandwidth of the network comprises
counting a number of bits of test data looped back from the second device, until receiving at least two looped back packet count messages having substantially equal count values; and
determining the bandwidth to be substantially equal to the number of bits looped back from the second device relative to the first interval.

41. The method of claim 38 wherein determining a bandwidth of the network comprises:
counting a number of packets of test data looped back from the second device, until receiving at least two looped back packet count messages having substantially equal count values; and
determining the bandwidth as a proportion of the first rate, wherein the proportion is based on the number of packets looped back from the second device relative to a total number of packets of test data transmitted by the first device during the first interval.

42. The method of claim 38 wherein determining a bandwidth of the network comprises:
counting a number of bits of test data looped back from the second device, until receiving a predetermined number of packet count messages; and
determining the bandwidth to be substantially equal to the number of bits looped back from the second device relative to a second interval, wherein the second interval corresponds to a duration of time needed to transmit the predetermined number of packet count messages.

43. The method of claim 42 wherein the second interval is less than the first interval.

44. The method of claim 38 wherein determining a bandwidth of the network comprises:
counting a number of packets of test data looped back from the second device, until receiving a predetermined number of packet count messages; and
determining the bandwidth as a proportion of the first rate, wherein the proportion is based on the number of packets looped back from the second device relative to a number of test packets transmitted by the first device during a second interval, and wherein the second interval corresponds to a duration of time needed to transmit the predetermined number of packet count messages.

45. The method of claim 24, wherein determining a bandwidth of the network comprises counting the amount of test data looped back from the second device during a third interval, wherein the third interval corresponds to a predetermined duration of time.

46. The method of claim 24, wherein determining a bandwidth of the network comprises:
determining, based on the one or more packets, whether the amount of test data received by the second device is less than the total amount of the test data transmitted by the first device; and
if it is determined that the amount of test data received by the second device is not less than the total amount of the test data transmitted by the first device, transmitting another plurality of test data to the second device at a second rate, wherein the second rate is greater than the first rate.

47. A network system comprising:
means for transmitting a plurality of test data, over the network, from a first device to a second device during a first interval of time;
means for receiving an amount of the test data at the second device; and
means for determining a bandwidth of the network based, at least in part, on the amount of the test data received by the second device, wherein the amount of test data received is less than a total amount of the test data transmitted by the first device during the first interval.

48. A system comprising:
a processing entity;
a memory coupled to said processing entity having data stored therein and having program code stored therein which, when executed by said processing entity, causes said processing entity to:
transmit a plurality of test data from a first device, over a network, to a second device during a first interval;
receive an amount of the test data at the second device; and
determine a bandwidth of the network based, at least in part, on the amount of the test data received by the second device, wherein the amount of test data received by the second device is less than a total amount of the test data transmitted by the first device during the first interval.
